(19) United States
(12) Patent Application Publication
(10) Pub. No.: US 2005/0238174 A1
(43) Pub. Date: Oct. 27, 2005

(54) Method and system for secure communications over a public network

(75) Inventor: Stuart S. Kreitzer, Coral Springs, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/829,900

(22) Filed: Apr. 22, 2004

(51) Int. Cl. H04L 9/00

(52) U.S. Cl. 380/277

(57) ABSTRACT

A method (100) of secure communications over a public network can include establishing a permanent key and an ordered sequence of limited use keys (102), enabling the use of the permanent key at any time (104) and enabling the use of the limited use keys for a predetermined usage (106). The step of establishing the order sequence of limited use keys can optionally include the step of establishing an ordered sequence of single-use keys (108). The method can further include the step of requesting (110) the ordered sequence of limited use keys from an access protected website and optionally storing (116) the ordered sequence of limited use keys and a respective status for each of the limited use keys. The method can further include the step of disabling (112) each of the limited use keys after the predetermined usage for each of the limited use keys.

### CROSS-REFERENCE TO RELATED APPLICATIONS

Not applicable

### FIELD OF THE INVENTION

This invention relates generally to secure communications, and more particularly to a method and system for secure usage of public networks.

### BACKGROUND OF THE INVENTION

Thousands of public internet terminals (PITs) are in operation all over the world in internet cafes, hotels, libraries, cruise ships, shopping centers, airports, and other areas. PITs are especially popular with travelers who have internet access at home and want occasional access when away from home or the office to check mail, access bank accounts, visit auction websites, or other common transactional web activities. Unfortunately, the security of PITs is threatened by growing instances of hacking to obtain passwords, user IDs, account numbers and other sensitive information. In one reported instance by the Associated Press on Oct. 10, 2003, a hacker had secretly installed software that logs individual keystrokes on Internet terminals that resided in more than a dozen stores of a major reputable copy-store vendor. For more than a year, this hacker was recording key stokes by users of Internet terminals and paying particular attention to their passwords. The hacker captured more than 450 user names and passwords, using them to access and even open bank accounts online. Such an account, only highlights the risks and dangers of using public Internet terminals at cybercafes, libraries, airports and other establishments.

Keyboard logging software poses a grave threat to the security of web transactions on public internet terminals, not to mention a threat to the public internet terminal industry itself. Keyboard logging software is easy to install and difficult to detect. The makers of keyboard logging software have developed sinister methods of silently installing keyboard logging software on computers often without physical access to the machine. For example, one software vendor makes a keyboard logging utility that can be remotely deployed using email and clandestinely monitored over the internet. Since keyboard logging software is generally invisible to the user of a PIT, a PIT user must assume that a keyboard logger may possibly be present and avoid typing in any sensitive information. In such a scenario, how does a user log into Yahoo, AOL, their work email account, or their bank account or other account without entering a password and user ID?

### SUMMARY OF THE INVENTION

A method and system of secure communication over a public network reduces the risk of using PITs without requiring any new hardware or software on existing public terminals in service. Users of public internet terminals cannot trust the security of existing terminals even when they are supplied from reputable providers as noted above. Terminals from lesser known providers are more likely to be riskier. Since it is impractical to inspect a public terminal for snoopware such as key loggers, embodiments in accordance with the invention makes these Trojan horses and other sinister software schemes useless because the password and user ID information collected expires and has a limited useful life and won't permit future access by a malicious hacker.

In a first embodiment of the present invention, a method of secure communications over a public network can include the steps of establishing a permanent key and an ordered sequence of limited use keys, enabling the use of the permanent key at any time and enabling the use of the limited use keys for a predetermined usage for each of the limited use keys in the ordered sequence. The step of establishing the order sequence of limited use keys can include the step of establishing an ordered sequence of single-use keys. The method can further include the step of disabling each of the limited use keys after the predetermined usage for each of the limited use keys in the ordered sequence respectively. The method can also include the step of masking sensitive information when a limited use key is used for a given session or suppressing the display of sensitive account information at logon when using a limited use key. The step of disabling can include the step of disabling a single use key after a single logon using the single use key or can involve the step of disabling a limited use key after at least one among a predetermined amount of logons or a predetermined amount of logon time or after an expiration period. The method can further include the step of requesting the ordered sequence of limited use keys from an access protected website and the step of storing the ordered sequence of limited use keys and a respective status for each of the limited use keys.

In a second embodiment of the present invention, a secure networking system can include at least one server and a processor forming a portion of the server. The processor can be programmed to establish a permanent key and an ordered sequence of limited use keys, enable the use of the permanent key at any time, enable the use of the limited use keys for a predetermined usage for each of the limited use keys in the ordered sequence, and disable each of the limited use keys after the predetermined usage for each of the limited use keys in the ordered sequence respectively. The processor can generally be programmed to perform many of the steps outlined in the method described above. For example, the processor can be further programmed to disable at least one among a single use key after a single login using the single use key, or disable a limited use key after at least one among a predetermined amount of logons or after a predetermined amount of logon time or after an expiration period.

In a third embodiment of the present invention, a computer program has a plurality of code sections executable by a machine for causing the machine to perform the steps described in the first embodiment above.

### BRIEF DESCRIPTION OF THE DRAWINGS

FIG. 1 is a block diagram of a networking system that reduces the risk of security lapses in accordance with an embodiment of the present invention.

FIG. 2 is a flow chart illustrating a method of reducing the risk of unauthorized access to a server in accordance with an embodiment of the present invention.

### DETAILED DESCRIPTION OF THE DRAWINGS

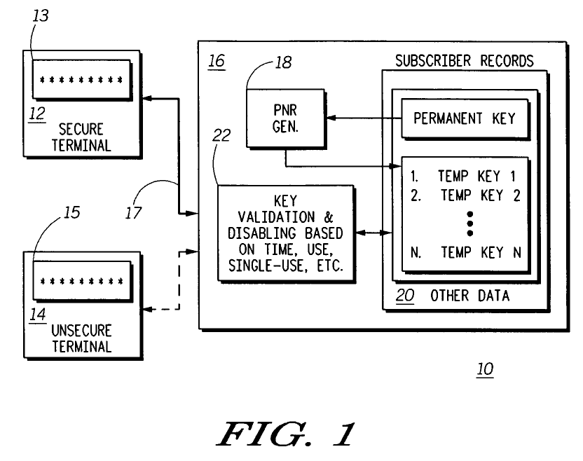

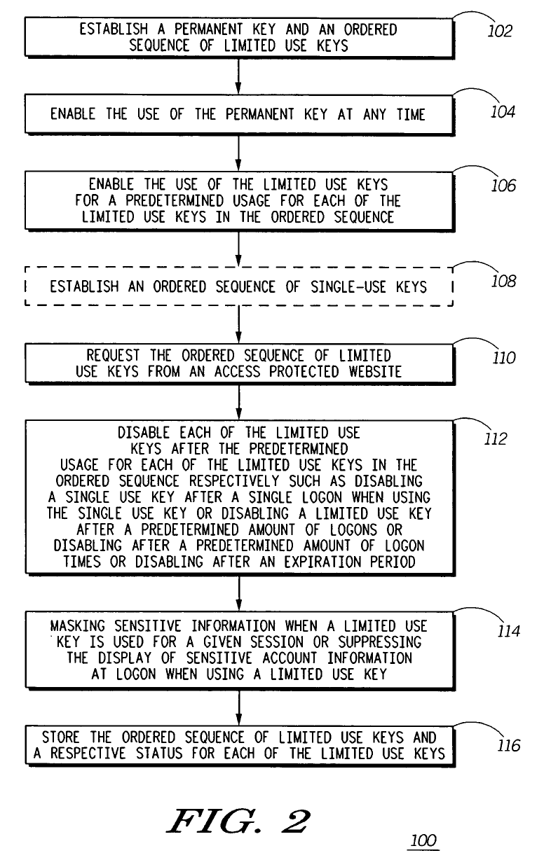

Referring to FIGS. 1 and 2, a method and system is shown for reducing the risk of using PITs without requiring any new hardware or software on the numerous existing public terminals already in service. Users of public internet terminals cannot trust the security of these terminals due to the chance that such terminals have installed insidious software such as snoopware or spyware such as key loggers that subject innocent users to identity theft and other computer crimes. By limiting the useful life of temporary passwords, such schemes as Trojan horses become useless to would-be hackers since the password and user ID information collected expires on a first use or on a limited use and won't permit future access by a malicious hacker.

In one embodiment, the methods and systems herein renders useless the most sensitive information gathered by keyboard logging software, namely, passwords and user IDs. In one embodiment, relatively simple modifications to websites can be done while requiring no changes to PITS and only a slight inconvenience to users. In this embodiment, in addition to the standard user ID and password that users obtain to access websites such as Yahoo or AOL, there can also be a means to request temporary user ID and password pairs from the same websites. A set of these temporary user ID/password pairs, hereafter called “mobile keys”, can be used while traveling or whenever someone needs to access public terminals. Unlike a user's main user ID/password, these mobile keys are good for only a limited use such as a single login and then expire immediately. The limited use can include a single use or logon, but can optionally or alternatively include limitations in usage time, or a limited number of logons or a limitation regarding when such mobile keys can be used (expirations or day-time use only). Participating websites, in addition to providing existing password management facilities, can furnish users with the ability to generate a number of mobile keys for use when traveling. For example, someone could request a list of 10 mobile key pairs from Yahoo to print out and carry with them on a trip. Each mobile key pair can be composed of randomly generated values that can only be used once to access the website in one example. The mobile key can expire as soon as it is used, so keyboard loggers, if present, will capture an expired and useless password.

Referring to FIG. 1, a secure networking system 10 can include secure terminals 12 and unsecure or public Internet terminals 14 each having respective displays 13 and 15. Each of the terminals 12, 14 can communicate with a server 16 having a website. The secure terminal 12 can communicate with the server via a secure communication link 17 such as a dedicated trunk line. The secure terminal 12 can be used to request the mobile keys as previously mentioned. The server 16 can maintain subscriber records 20 in memory in a database or other suitable format. Access to a given subscriber record can be controlled by only allowing use with authorized user IDs and passwords which can be stored in association with the given subscriber record. The authorized user ID's and passwords can include a permanent key and a plurality of temporary keys or mobile keys. The mobile keys can be generated using a random number generator or pseudo-random number generator 18. The server can also include algorithms or routines 22 to validate and/or disable keys based on time, usage, single-use, or other criteria as desired. Thus, a user accessing the given subscriber record 20 on the server 16 can use a mobile or temporary key on the unsecure terminal 14 without fear of surreptitiously loaded keyboard loggers on the unsecure terminal 14 since the mobile or temporary key will expire after the authorized user's session or soon thereafter.

Referring to FIG. 2, a flow chart illustrating a method 100 of secure communications over a public network can include the step 102 of establishing a permanent key and an ordered sequence of limited use keys, enabling the use of the permanent key at any time at step 104 and enabling the use of the limited use keys for a predetermined usage at step 106 for each of the limited use keys in the ordered sequence. The step of establishing the order sequence of limited use keys can optionally include the step 108 of establishing an ordered sequence of single-use keys. The method 100 can further include the step 110 of requesting the ordered sequence of limited use keys from an access protected website and optionally storing at step 116 the ordered sequence of limited use keys and a respective status for each of the limited use keys. The method 100 can further include the step 112 of disabling each of the limited use keys after the predetermined usage for each of the limited use keys in the ordered sequence respectively. The step of disabling can include the step of disabling a single use key after a single logon using the single use key or can involve the step of disabling a limited use key after at least one among a predetermined amount of logons or a predetermined amount of logon time or after an expiration period. The method 100 can also include the step 114 of masking sensitive information when a limited use key is used for a given session or suppressing the display of sensitive account information at logon when using a limited use key. The displays 13 and 15 in FIG. 1 for the terminals 12 and 14 respectively show such masking or suppression of displays. Further note that the order of steps described above are only provided as an example and can certainly be performed in different order as appropriate.

In a practical example in accordance with an embodiment of the present invention, a user would recognize the need to use public terminals in the near future on an upcoming trip for example. The user can then log onto the access-protected website ahead of time (usually from their own PC at home or work) to request and print a list of mobile or temporary keys. Since each mobile key expires as soon as it is used in the case of single-use mobile keys, the user can anticipate how many logins they might need and requests an adequate number of mobile keys. There is no downside to requesting more mobile keys than actually needed. For example, 10 mobile keys for a 5 day trip could be requested by the user to cover the anticipated need with a few spare keys, just in case.

The user can simply carry the list of key pairs with them, perhaps in their wallet or purse on a piece of paper or on a personal digital assistant or other device having memory. To use a secure website such as Yahoo on a public terminal, the user can enter a mobile key from their list and cross it off the list (or delete it from memory) since it won't be valid again. In a single-use embodiment, each mobile key permits one-time access to the site.

Implementation can be straight-forward in that websites can provide a facility for generating, storing, and expiring mobile keys. Websites providing this feature would provide a page where the user could request a set of mobile keys and perform other maintenance operations such as canceling mobile keys that are no longer needed. Most likely, the website would also keep the user's primary user ID and password active in addition to the mobile keys since the primary ID/password may still be used from a trusted terminal.

Another aspect involves protecting against screen logging programs that record information displayed on the terminal. The best way to protect against screen logging is for websites to alter some of the information that is displayed to prevent screen-logging programs from capturing enough sensitive information to pose a risk. For example, when accessing a bank account on-line, the financial institution website could suppress the display of sensitive account numbers and account names whenever mobile keys are used to logon. In many instances, financial institutions and other organizations already suppress the display of permanent keys or at least passwords. In any event, the website can use the fact that a mobile key is being used to logon as an indication that special security measures such as suppressing the display of certain information or perhaps denying access to very sensitive information should be enforced. By suppressing the display of very sensitive information when a mobile key is used at logon, the website effectively renders hacking via a screen logger a useless exercise because, for example, account balance information without knowing names or account numbers would be of no value to a hacker.

A single website could be used to act as a consolidator of mobile keys for other websites that support mobile keys. For example, a website could be developed that would allow a user to logon and generate a single set of mobile keys that would work for multiple websites such as Hotmail, Yahoo, AOL or other websites. In this instance, the user can access this consolidator site to generate mobile keys and the keys could be sent automatically to sites identified by the user. The consolidator arrangement can permit one set of mobile keys to access multiple websites instead of the user needing to carry several lists of mobile keys.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

Additionally, the description above is intended by way of example only and is not intended to limit the present invention in any way, except as set forth in the following claims.

1. A method of secure communications over a public network, comprising the steps of:
establishing a permanent key and an ordered sequence of limited use keys;
enabling the use of the permanent key at any time;
enabling the use of the limited use keys for a predetermined usage for each of the limited use keys in the ordered sequence; and
disabling each of the limited use keys after the predetermined usage for each of the limited use keys in the ordered sequence respectively.

2. The method of claim 1, wherein the method further comprises the step of masking sensitive information when a limited use key is used for a given session.

3. The method of claim 1, wherein the method further comprises the step of suppressing the display of sensitive account information at logon when using a limited use key.

4. The method of claim 1, wherein the step of establishing the order sequence of limited use keys comprises the step of establishing an ordered sequence of single-use keys.

5. The method of claim 4, wherein the step of disabling comprises the step of disabling a single use key after a single logon using the single use key.

6. The method of claim 1, wherein the step of disabling comprises the step of disabling a limited use key after at least one among a predetermined amount of logons or a predetermined amount of logon time or after an expiration period.

7. The method of claim 1, wherein the method further comprises the step of requesting the ordered sequence of limited use keys from an access protected website.

8. The method of claim 1, wherein the method further comprises the step of storing the ordered sequence of limited use keys and a respective status for each of the limited use keys.

9. A secure networking system, comprising:
at least one server; and
a processor forming a portion of the server, wherein the processor is programmed to:
establish a permanent key and an ordered sequence of limited use keys;
enable the use of the permanent key at any time;
enable the use of the limited use keys for a predetermined usage for each of the limited use keys in the ordered sequence; and
disable each of the limited use keys after the predetermined usage for each of the limited use keys in the ordered sequence respectively.

10. The system of claim 9, wherein the processor is further programmed to mask sensitive information when a limited use key is used for a given session.

11. The system of claim 9, wherein the processor is further programmed to suppress the display of sensitive account information at logon when using a limited use key.

12. The system of claim 9, wherein the processor is further programmed in establishing the order sequence of limited use keys by establishing an ordered sequence of single-use keys.

13. The system of claim 12, wherein the processor is further programmed in disabling by disabling at least one among a single use key after a single login using the single use key, or disabling a limited use key after at least one among a predetermined amount of logons or after a predetermined amount of logon time or after an expiration period.

14. The system of claim 9, wherein the processor is further programmed to receive requests for and provide the ordered sequence of limited use keys from an access protected website.

15. The system of claim 9, wherein the processor is further programmed to store the ordered sequence of limited use keys and a respective status for each of the limited use keys.

16. A machine readable storage, having stored thereon a computer program having a plurality of code sections executable by a machine for causing the machine to perform the steps of:
establish a permanent key and an ordered sequence of limited use keys;
enable the use of the permanent key at any time;
enable the use of the limited use keys for a predetermined usage for each of the limited use keys in the ordered sequence; and
disable each of the limited use keys after the predetermined usage for each of the limited use keys in the ordered sequence respectively.

17. The machine readable storage of claim 16, wherein the computer program further has a plurality of code sections executable by the machine for causing the machine to perform the step of disabling by disabling at least one among a single use key after a single login using the single use key, or disabling a limited use key after at least one among a predetermined amount of logons or after a predetermined amount of logon time or after an expiration period.
